(19) United States
(12) Patent Application Publication
(10) Pub. No.: US 2022/0012707 A1
(43) Pub. Date: Jan. 13, 2022

(54) TRANSACTION TYPE CATEGORIZATION FOR ENHANCED SERVICING OF PEER-TO-PEER TRANSACTIONS

(71) Applicant: PAYPAL, INC., San Jose, CA (US)

(72) Inventors: Sandeep Krishnan GOPALAKRISHNAN NAIR, Campbell, CA (US); Shilpa Dhar, Los Altos, CA (US)

(21) Appl. No.: 16/926,459

(22) Filed: Jul. 10, 2020

(51) Int. Cl. G06Q 20/22

(52) U.S. Cl. CPC G06Q 20/223

(57) ABSTRACT

Systems and methods for transaction type categorization for enhanced servicing of peer-to-peer transactions are provided. A transaction processing application running on a communication device in communication with an electronic payment provider can generate a transaction request indicating parameters for processing a transaction with a first service and communicate the transaction request to the electronic payment provider. The application can receive an indication of transaction type categorization options to assign to the transaction based on an assessment of the parameters, and display a prompt indicating the transaction type categorization options for completing the transaction request. The application can receive input indicating selection of a second transaction type categorization associated with a second service different from the first service from the transaction type categorization options and communicate the transaction request indicating the selection of the second transaction type categorization for processing the transaction with the first service and the second service.

### TECHNICAL FIELD

The present application generally relates to transaction processing systems and methods, and in particular to transaction type categorization for enhanced servicing of peer-to-peer transactions.

### BACKGROUND

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider. Such payment service providers can make transactions easier and safer for the parties involved. Purchasing with the assistance of a payment service provider from the convenience of virtually anywhere using a mobile device is one main reason why on-line and mobile purchases are growing very quickly.

Many payment transactions enabled by online or mobile payment service providers such as, for example, retail purchases, payment transactions, and the like, are made electronically using electronic devices, such as mobile phones or mobile computing devices. For example, a consumer may install a payment application provided by the payment service provider on his or her mobile device to facilitate payments to various merchants or recipients.

### BRIEF DESCRIPTION OF THE DRAWINGS

FIG. 1 illustrates a block diagram of a networked system suitable for implementing the processes described herein, according to an implementation of the present disclosure;

FIG. 2 illustrates a simplified message exchange in a networked system, according to an implementation of the present disclosure;

FIG. 3 illustrates a block diagram of a payment service module, according to an implementation of the present disclosure;

FIG. 4 conceptually illustrates an exemplary workflow of transaction type categorization through a user interface, according to an implementation of the present disclosure;

FIG. 5 conceptually illustrates another exemplary workflow of transaction type categorization through a user interface, according to an implementation of the present disclosure;

FIG. 6 conceptually illustrates yet another exemplary workflow of transaction type categorization through a user interface, according to an implementation of the present disclosure;

FIG. 7 is an exemplary system environment of an artificial neural network implementing a machine learning model trained for classifications based on training data, according to an implementation of the present disclosure;

FIG. 8 is a flowchart of an example process of transaction type categorization by a transaction processing application at a user device, according to an implementation of the present disclosure;

FIG. 9 is a flowchart of an example process of transaction type categorization by a service provider server, according to an implementation of the present disclosure; and

FIG. 10 is a block diagram of a computer system suitable for implementing one or more components in FIG. 1, according to an implementation.

Implementations of the present disclosure and their advantages are best understood by referring to the detailed description that follows. It should be appreciated that like reference numerals are used to identify like elements illustrated in one or more of the figures, wherein showings therein are for purposes of illustrating implementations of the present disclosure and not for purposes of limiting the same.

### DETAILED DESCRIPTION

Traditional payment provider services involved in peer-to-peer transactions may need to evolve from a focused peer-to-peer environment to a larger ecosystem, connecting users to all recipient parties receiving monetary funds from the users. As part of that evolution, users of the payment provider services may inherently expect a payment provider platform to provide “trust and safety” as these users increasingly engage in commerce on the payment provider platform. In some instances, sending monetary funds to recipients designated as friends and family is typically considered a generally safe medium for funds transfer, so the payment provider can provide a service that protects the fund transfer for this type of transaction or type of recipient. However, the payment provider platform may not offer a service that provides a similar “trust and safety” benefit to transactions involving commerce (e.g., transactions issued by a merchant for the purchase of a good or service).

Even though policies of a payment provider platform may not allow transactions (e.g., payments) to be made for commercial transactions, many users utilize the payment provider platform for payments to a recipient (e.g., merchant) for sale of goods and services. When some of these commercial transactions are not fulfilled by the recipient of those payments, the sender of those payments is fraudulently deprived of receiving the purchased good or service without any remedial course for reversing the transfer of those payments. Users that are fraudulently deprived of a service or good is a primary reason for user disputes being transmitted to the payment provider whom are reporting fraudulent activity and requesting a remedy. However, some of these user disputes may not correctly identify the transactions as a commercial transaction. As a result, the dispute rate increases based on all types of transactions being disputed for fraudulent activity, which increases the amount of risk posed to the payment provider for protecting against fraudulent activity in commercial transactions. As such, a mechanism to identify a transaction as a commercial transaction to enable the payment provider to properly distinguish between commercial and non-commercial transactions and provide proper services that helps reduce fraudulent activity and/or provide a remedy to senders that are fraudulently deprived of a service or good associated with the commercial transaction.

The subject technology provides for transaction type categorization to provide enhanced servicing of peer-to-peer transactions. For example, a communication device running a transaction processing application for processing a payment request can mark a transaction with a transaction type categorization to notify an electronic payment provider of whether the transaction requires enhanced servicing by assigning payment protections to a sender device as a remedy for any possible fraudulent activity with respect to the transaction based on the transaction type categorization. The subject technology includes a transaction processing application running on a communication device (e.g., a user device) that can generate a transaction request to process a transaction to a recipient device with a first service, in which the transaction request indicates a plurality of parameters associated with the transaction. The transaction processing application can communicate, with a transaction processing server through an application programming interface (API), at least a portion of the transaction request including the plurality of parameters associated with the transaction. The transaction processing application can receive, from the transaction processing server through the API, an indication of one or more transaction type categorization options to assign to the transaction based on at least a portion of the plurality of parameters associated with the transaction. The transaction processing application can provide, for display, a prompt indicating the one or more transaction type categorization options for completing the transaction request. The transaction processing application can receive, through the prompt, input indicating selection of a second transaction type categorization associated with a second service different from the first service from the one or more transaction type categorization options. The transaction processing application can communicate, with the transaction processing server through the API, the transaction request indicating the selection of the second transaction type categorization for processing the transaction with the first service and the second service. In this regard, the first service corresponds to a payment processing service for processing the transaction request as a peer-to-peer transaction to transfer monetary funds to a recipient device from a funding source associated with the transaction processing application, and the second service corresponds to a payment protection service for the sender device of the monetary funds by assigning the transaction type categorization to the transaction.

The subject technology provides several benefits in transaction processing systems such as increasing the level of engagement between users and the electronic payment provider through the transaction processing application by assigning payment protections for transactions marked with a certain transaction type categorization, such as commercial transactions. By assigning a transaction type categorization to a transaction facilitated through the payment processing server, the rate of disputes transmitted from users to the transaction processing server can be decreased significantly, since the transaction processing server can operate in identifying any transactions involved in fraudulent activity and providing a remedy to senders associated with such transactions in an automated manner (e.g., without user interaction via transmitted dispute requests).

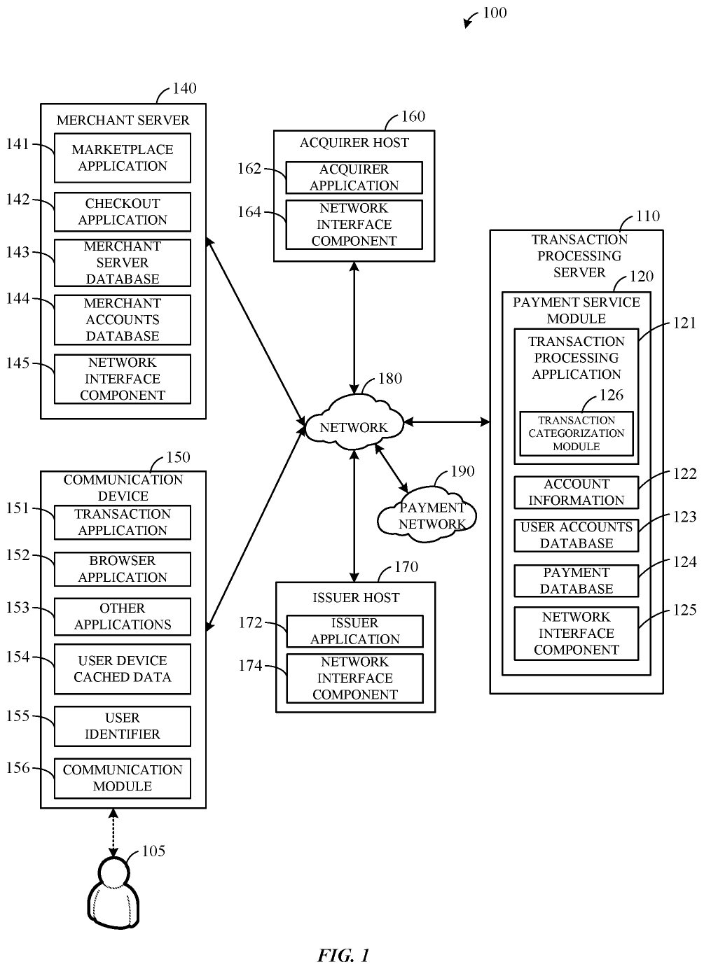

FIG. 1 is a block diagram of a networked electronic transaction system 100 suitable for implementing the processes described herein, according to an implementation of the present disclosure. The electronic transaction system 100 includes a transaction processing server 110 associated with an electronic payment provider, a merchant server 140, and a communication device 150 that may be communicatively coupled with each other via a network 180. The electronic transaction system 100 also includes an acquirer host 160, an issuer host 170 and a payment network 190, communicably coupled to the transaction processing server 110 via the network 180. In some implementations, the transaction processing server 110 may be communicably coupled directly to each of the acquirer host 160 and/or the issuer host 170. The network 180, in one implementation, may be implemented as a single network or a combination of multiple networks. For example, in various implementations, the network 180 may include the Internet and/or one or more intranets, landline networks, wireless networks, and/or other appropriate types of communication networks. In another example, the network 180 may include a wireless telecommunications network (e.g., cellular phone network) adapted to communicate with other communication networks, such as the Internet.

The transaction processing server 110, in one implementation, may be maintained by a transaction processing entity or an electronic service provider, which may provide electronic services (e.g., selling of merchandise processing, purchasing of merchandise, performing electronic transactions, etc.). As such, the transaction processing server 110 may include a payment service module 120, which may be adapted to interact with the communication device 150 and/or the merchant server 140 over the network 180 to facilitate the searching, selection, purchase, payment of items, and/or other services offered by the transaction processing server 110. In one example, the transaction processing server 110 may be provided by PayPal®, Inc. of San Jose, Calif., USA, and/or one or more financial institutions or a respective intermediary that may provide multiple point of sale devices at various locations to facilitate transaction routings between merchants and, for example, financial institutions. In various implementations, the payment service module 120 includes a transaction processing application 121, account information 122, a user accounts database 123, payment database 124, and a network interface component 125. The transaction processing application 121 includes a transaction categorization module 126.

In some implementations, the transaction processing application 121 is adapted to process purchases and/or payments for financial transactions between a user and a merchant. In one implementation, the transaction processing application 121 assists with resolving financial transactions through validation, delivery, and settlement. As such, the transaction processing application 121 settles indebtedness between a user and a merchant, in which accounts may be directly and/or automatically debited and/or credited of monetary funds in a manner as accepted by the banking industry.

In certain embodiments, the transaction processing application 121 may allow for a user to conduct one or more transactions using the application and the electronic device. Such an application may be, for example, a dedicated purchasing application linked with a transaction service (e.g., eBay®), a merchant (e.g., Nordstrom®), and/or a payment service (e.g., PayPal® or Venmo®). The transaction processing application 121 may be a single application or a plurality of separate applications linked together. Thus, for example, the transaction processing application 121 may be a combination of a purchasing application, a payment application, and a communication application. In various embodiments, the transaction processing application 121 may also include financial applications, such as banking, online payments, money transfer, or other applications.

The subject technology provides for transaction type categorization to provide enhanced servicing of peer-to-peer transactions. For example, the transaction processing server 110 can be notified of whether a received transaction request from a sender device (e.g., the communication device 150) includes a transaction with a certain transaction type categorization that indicates the transaction requires enhanced servicing by assigning payment protections to the sender device as a remedy for any possible fraudulent activity with respect to the transaction based on the transaction type categorization. In some embodiments, the transaction processing server 110, using the transaction categorization module 126, can receive, from the transaction application 151 associated with the communication device 150 through the API 302, at least a portion of a transaction request including a plurality of parameters associated with a transaction for processing the transaction to a recipient device with a first service.

The transaction processing server 110, using the transaction categorization module 126, can determine whether at least a portion of the plurality of parameters associated with the transaction satisfy a set of rules for invoking a second service different from the first service.

The transaction processing server 110, using the transaction categorization module 126, can communicate, with the transaction application 151 through the network interface component 125, an indication of a plurality of transaction type categorization options respectively associated with the first service and the second service when the at least the portion of the plurality of parameters associated with the transaction is determined to satisfy the set of rules. In some aspects, the indication includes a request to the transaction processing application to assign one of the plurality of transaction type categorization options to the transaction.

The transaction processing server 110, using the transaction categorization module 126, can receive, from the transaction application 151 associated with the communication device 150 through the network interface component 125, the transaction request indicating selection of a first transaction type categorization from the plurality of transaction type categorization options for processing the transaction with the first service and the second service. In this respect, the transaction processing server 110 can process the transaction request with payment protections assigned to the sender device, of which the user 105 associated with the communication device 150 can interact with the transaction processing server 110 through the transaction application 151 with peace of mind knowing the transaction has the payment protection service attached.

In other embodiments, the transaction processing server 110, using the transaction categorization module 126, can communicate, with the transaction application 151 through the network interface component 125, an indication of a transaction type categorization option when the at least the portion of the plurality of parameters associated with the transaction is determined not to satisfy the set of rules. In this regard, the transaction processing server 110, using the transaction categorization module 126, can receive, from the transaction application 151 associated with the communication device 150 through the network interface component 125, the transaction request indicating selection of the transaction type categorization option for processing the transaction with the first service with exclusion from the second service. In this respect, the transaction processing server 110 can process the transaction request without any payment protections assigned to the sender device.

The payment service module 120, in one implementation, may be adapted to maintain one or more user accounts, merchant accounts, and transaction records in the user accounts database 123. As such, the user accounts database 123 may store account information associated with one or more individual users (e.g., the user associated with communication device 150) and merchants and transaction data associated with transactions. For example, account information may include private financial information of users and merchants, such as one or more account numbers, passwords, credit card information, banking information, digital wallets used, or other types of financial information. The transaction records may include Internet Protocol (IP) addresses, device information associated with the transaction, transaction dates, transaction amounts, payor identities, payee identities, etc. In certain implementations, account information also includes user purchase profile information such as account funding options and payment options associated with the user, payment information, receipts, and other information collected in response to completed funding and/or payment transactions.

In some aspects, each of the user accounts stored in the user accounts database 123 may include account information 122 associated with consumers, merchants, and funding sources, such as credit card companies. For example, account information 122 may include private financial information of users of devices such as account numbers, passwords, device identifiers, usernames, phone numbers, credit card information, bank information, or other financial information which may be used to facilitate online transactions by user 105. Advantageously, the payment service module 120 may be adapted to interact with merchant server 140 on behalf of user 105 during a transaction with the checkout application 142 to track and manage purchases made by users and which and when funding sources are used.

The transaction processing application 121, which may be part of payment service module 120 or separate, may be configured to receive information from the communication device 150 and/or merchant server 140 for processing and storage in the payment database 124. The transaction processing application 121 may include one or more applications to process information from user 105 for processing an order and payment using various selected funding instruments, as described herein. As such, transaction processing application 121 may store details of an order from individual users, including funding source used, credit options available, etc. The payment service module 120 may be further configured to determine the existence of and to manage accounts for user 105, as well as create new accounts if necessary.

In various implementations, transaction processing server 110 includes at least one network interface component 125 adapted to communicate with merchant server 140 and/or other entities over network 180. In various implementations, network interface component 125 may include a modem, an Ethernet device, a broadband device, a satellite device and/or various other types of wired and/or wireless network communication devices including microwave, radio frequency (RF), and infrared (IR) communication devices.

Merchant server 140 may include a merchant server database 143 identifying available products and/or services (e.g., collectively referred to as items) made available by, or on behalf of, a merchant associated with the communication device 150, for viewing and purchase by a non-merchant user device (not shown). According to various aspects of the present disclosure, the merchant server 140 may also host a website for an online marketplace, where sellers and buyers may engage in purchasing transactions with each other. The descriptions of the items or products offered for sale by the merchants (also referred to as “sellers”) may be stored in the merchant server database 143. The merchant may have a physical point-of-sale (POS) store front. The merchant may be a participating merchant who has a merchant account with an online marketplace provider via the merchant server 140 and a user account with the electronic payment provider via the transaction processing server 110. Merchant server 140 may be used for POS or online purchases and transactions. The merchant server 140, in various implementations, may be maintained by a business entity (or in some cases, by a partner of a business entity that processes transactions on behalf of business entity). Examples of businesses entities include an online marketplace sites, merchant sites, resource information sites, utility sites, real estate management sites, social networking sites, etc., which offer various items for purchase and process payments for the purchases. Generally, merchant server 140 may be maintained by anyone or any entity that receives money, which includes charities as well as retailers and restaurants. For example, a purchase transaction may be payment or gift to an individual. Although only one merchant server is shown, a plurality of merchant servers may be utilized if the user is purchasing products from multiple merchants.

The merchant server 140, in one implementation, may include a marketplace application 141, which may be adapted to provide information over the network 180 to the network interface component 145 of the communication device 150. For example, the user of the communication device 150 may interact with the marketplace application 141 through the network interface component 145 over the network 180 to search and view various items available for purchase in the merchant server database 143.

Merchant server 140 also may include a checkout application 142 which may be configured to facilitate the purchase by a user of goods or services online or at a physical point-of-service (POS) or store front. Checkout application 142 may be configured to accept payment information from or on behalf of the user through transaction processing server 110 over the network 180. For example, checkout application 142 may receive and process a payment confirmation from the transaction processing server 110 via the payment service module 120, as well as transmit transaction information to the payment service module 120 and receive information from the payment service module 120 (e.g., a transaction ID). Checkout application 142 may be configured to receive payment via a plurality of payment methods including cash, credit cards, debit cards, checks, money orders, or the like.

Merchant server 140 may further include the merchant server database 143 stored on a transitory and/or non-transitory memory of communication device 150, which may store various applications and data and be utilized during execution of various modules of communication device 150. Merchant server database 143 may include, for example, identifiers such as operating system registry entries, cookies associated with marketplace application 141, identifiers associated with hardware of communication device 150, or other appropriate identifiers, such as identifiers used for payment/user/device authentication or identification, which may be communicated as identifying the user/communication device 150 to transaction processing server 110. Merchant server database 143 may further include any transaction data sets used for training and/or processing with a machine learning model generated by transaction processing server 110.

The merchant accounts database 144 may be adapted to store information about merchant accounts registered to merchant devices, including the communication device 150. The merchant accounts may be indicative of the merchant devices having access to a service provided by the merchant server 140. The merchant accounts database 144, in one implementation, may include at least one merchant identifier (not shown), which may be included as part of the one or more items made available for purchase so that, e.g., particular items are associated with the particular merchants. In one implementation, the merchant identifier may include one or more attributes and/or parameters related to the communication device 150, such as business and banking information. The merchant identifier may include attributes related to the merchant server 140, such as identification information (e.g., a serial number, a location address, GPS coordinates, a network identification number, etc.).

Merchant server 140 includes at least one network interface component 145 adapted to communicate with transaction processing server 110. In various implementations, network interface component 145 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 180 may be implemented as a single network or a combination of multiple networks. For example, in various implementations, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of the electronic transaction system 100.

Still referring to FIG. 1, the payment network 190 may be operated by payment card service providers or card associations, such as DISCOVER™, VISA™ MASTERCARD™, AMERICAN EXPRESS™, RUPAY™, CHINA UNION PAY™ etc. The payment card service providers may provide services, standards, rules, and/or policies for issuing various payment cards. A network of communication devices, servers, and the like also may be established to relay payment related information among the different parties of a payment transaction.

The acquirer host 160 includes an acquirer application 162 and a network interface component 164, and is communicably coupled to the transaction processing server 110 and/or the merchant server 140 through the network interface component 164 over the network 180. The acquirer host 160 may be a server operated by an acquiring bank. An acquiring bank is a financial institution that accepts payments on behalf of merchants. For example, a merchant may establish an account at an acquiring bank to receive payments made via various payment cards through the acquirer application 162. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

The issuer host 170 includes an issuer application 172 and a network interface component 174 and is communicably coupled to the transaction processing server 110 and/or the merchant server 140 through the network interface component 174 over the network 180. The issuer host 170 may be a server operated by an issuing bank or issuing organization of payment cards through the issuer application 172. The issuing banks may enter into agreements with various merchants to accept payments made using the payment cards. The issuing bank may issue a payment card to a user after a card account has been established by the user 105 at the issuing bank. The user then may use the payment card to make payments at or with various merchants who agreed to accept the payment card.

The communication device 150, in various implementations, may be implemented using any appropriate combination of hardware and/or software configured for wired and/or wireless communication over the network 180. In various implementations, the communication device 150 may be implemented using any appropriate hardware and software configured for wired and/or wireless communication over network 180. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data.

The communication device 150 may install and execute a transaction application 151 received from the transaction processing server 110 to facilitate one or more transaction processes (e.g., peer-to-peer payments). The transaction application 151 may allow a user to send payment transaction requests to the transaction processing server 110, which includes communication of data or information needed to complete the request, such as funding source information.

User device 150 may include one or more browser applications 152 that may be used, for example, to provide a convenient interface to permit user 105 to browse information available over network 180. For example, in one embodiment, browser application 152 may be implemented as a web browser configured to view information available over the Internet, such as a user account for online shopping and/or merchant sites for viewing and purchasing goods and/or services.

The communication device 150, in various implementations, may include other applications 153 as may be desired in one or more implementations of the present disclosure to provide additional features available to the user. For example, other applications 153 may include security applications for implementing server-side security features, programmatic client applications for interfacing with appropriate APIs over network 180, or other types of applications. Other applications 153 may also include email, texting, voice and IM applications that allow a user to send and receive emails, calls, texts, and other notifications through network 180. In various implementations, other applications 153 may include financial applications, such as banking, online payments, money transfer, or other applications associated with transaction processing server 110. Other applications 153 includes a software program, such as a graphical user interface (GUI), executable by a processor that is configured to interface to a user.

The communication device 150 may further include user device cached data 154 stored to a transitory and/or non-transitory memory of communication device 150, which may store various applications and data and be utilized during execution of various modules of communication device 150. Thus, user device cached data 154 may include, for example, identifiers such as operating system registry entries, cookies associated with browser application 152 and/or other applications 153, identifiers associated with hardware of communication device 150, or other appropriate identifiers, such as identifiers used for payment/user/device authentication or identification, which may be communicated as identifying communication device 150 to merchant server 140. In various implementations, account information and/or digital wallet information may be stored to user device cached data 154 for use by communication device 150.

The communication device 150, in one implementation, may include at least one user identifier 155, which may be implemented, for example, as operating system registry entries, cookies associated with the communication module 156, identifiers associated with hardware of the communication device 150 (e.g., a media control access (MAC) address), or various other appropriate identifiers. The user identifier 155 may include one or more attributes related to the user of the communication device 150, such as personal information related to the user (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 155 may be passed with a user login request to the transaction processing server 110 via the network 180, and the user identifier 155 may be used by the transaction processing server 110 to associate the user with a particular user account maintained by the transaction processing server 110.

In conjunction with the user identifier 155, communication device 150 may also include a trusted zone owned or provisioned by the transaction processing server 110 with agreement from a device manufacturer. The trusted zone may also be part of a telecommunications provider smart card that is used to store appropriate software by the transaction processing server 110 capable of generating secure industry standard payment credentials as a proxy to user payment credentials.

User device 150 includes at least one communication module 156 adapted to communicate with the merchant server 140 and/or the transaction processing server 110. In various implementations, communication module 156 may include a modem, an Ethernet device, a broadband device, a satellite device and/or various other types of wired and/or wireless network communication devices including microwave, radio frequency, infrared, Bluetooth, and near field communication devices.

Even though only one communication device 150 is shown in FIG. 1, it has been contemplated that one or more user devices (each similar to communication device 150) may be communicatively coupled with the transaction processing server 110 via the network 180 within the networked electronic transaction system 100.

The communication device 150 may also use the merchant server 140 to communicate with the transaction processing server 110 over the network 180. For example, the communication device 150 may use the merchant server 140 to communicate with the transaction processing server 110 in the course of various services offered by the service provider to a merchant, such as a payment intermediary between customers of the merchant and the merchant itself. For example, the merchant server 140 may use an API that allows it to offer sale of goods in which customers are allowed to make payment through the transaction processing server 110, while the user may have an account with the transaction processing server 110 that allows the user to use the transaction processing server 110 for making payments to merchants that allow use of authentication, authorization, and payment services of the service provider as a payment intermediary. The merchant may also have an account with the transaction processing server 110. Even though only one merchant server 140 is shown in FIG. 1, it has been contemplated that one or more merchant servers (each similar to merchant server 140) may be communicatively coupled with the transaction processing server 110 and the communication device 150 via the network 180 in the electronic transaction system 100.

Browser application 152 may correspond to one or more processes to execute modules and associated specialized hardware of communication device 150 that provides an interface and/or online marketplace to sell one or more items offered by a merchant (not shown) associated with communication device 150, and further provide checkout and payment processes for a transaction to purchase the items for sale from the merchant corresponding to communication device 150, where such transaction processing services may be provided through payment service module 120. In this regard, browser application 152 may correspond to specialized hardware and/or software of communication device 150 to provide a convenient interface to permit a merchant to offer items for sale. For example, browser application 152 may be implemented as an application offering items for sale that may be utilized by the merchant or a merchant employee to enter items selected by a user to a transaction, determine a price for the transaction, and initiate a checkout and payment process for the transaction.

In certain implementations, browser application 152 may correspond to a website available over the Internet and/or online content and/or database information accessible through a dedicated application. Thus, browser application 152 may provide item sales through an online marketplace using the website of the merchant. However, in other implementations, communication device 150 may be local to a physical merchant location and provide transaction processing processes through interfaces displayed to a merchant or merchant employee at the merchant location. Browser application 152 may include information for a price for the item, a discount for the item, a price change for the item, and/or other incentives for items and/or with the merchant corresponding to communication device 150 (e.g., rebates, payments, etc.). Browser application 152 may be used to set and/or determine a benefit or incentive provided to a user of a communication device (not shown). The sales data and other item data may be retrievable by the communication device 150 and/or payment service module 120, such as requestable through an API call, retrievable from a database, and/or scraped from an online resource.

Browser application 152 may be used to establish a transaction once the user 105 associated with communication device 150 has selected one or more items for purchase. Once a payment amount is determined for the transaction for the item(s) to be purchased, browser application 152 may request payment from the user through a transaction processing flow provided by the payment service module 120. Browser application 152 may receive payment processing information. Thus, payment provided to the merchant account, and notification of payment (or failure, for example, where there are insufficient user funds) may be sent to browser application 152. The payment may be made by payment service module 120 on behalf of the user 105 associated with the communication device 150. In other implementations, browser application 152 may direct the user to one or more interfaces provided by payment service module 120 for transaction processing.

Thus, browser application 152 may include one or more interfaces to engage in a transaction processing flow. In other implementations, the merchant may not view the transaction processing, which may be performed by the user 105 associated with the communication device 150. Browser application 152 may then receive the results of the transaction processing, and complete the transaction with the user 105, for example, by providing the user 105 the items for the transaction or declining the transaction where the user 105 is not authenticated or the transaction is not authorized (e.g., insufficient funds).

In one implementation, the browser application 152 includes a browser module that provides a network interface to browse information available over the network 180. For example, the browser module may be implemented, in part, as a web browser to view information available over the network 180. The browser application 152, in one implementation, includes a user interface (e.g., a web browser, a mobile application, etc.), which may be utilized by the merchant to conduct electronic transactions (e.g., selling, perform electronic payments, etc.) with the merchant server 140 over the network 180. In one aspect, sale transactions earnings may be directly and/or automatically added to an account related to the merchant via the browser application 152.

A user 105, such as a consumer, may utilize communication device 150 to perform an electronic transaction using transaction processing server 110. For example, user 105 may utilize communication device 150 to visit a merchant's web site provided by merchant server 140 or the merchant's brick-and-mortar store to browse for products offered by the merchant. Further, user 105 may utilize communication device 150 to initiate a payment transaction, receive a transaction approval request, or reply to the request. Note that a transaction, as used herein, refers to any suitable action performed using the user device, including payments, transfer of information, display of information, etc. Although only one merchant server is shown, a plurality of merchant servers may be utilized if the user is purchasing products from multiple merchants.

In one implementation, the user 105 may have identity attributes stored with the payment service module 120, and the user may have credentials to authenticate or verify identity with the payment service module 120. User attributes may include personal information, banking information and/or funding sources. In various aspects, the user attributes may be passed to the payment service module 120 as part of a login, search, selection, purchase, and/or payment request, and the user attributes may be utilized by the payment service module 120 to associate the user with one or more particular user accounts maintained by the payment service module 120.

The subject technology provides for transaction type categorization to provide enhanced servicing of peer-to-peer transactions. For example, the communication device 150 running the transaction application 151 for processing a payment request can mark a transaction with a transaction type categorization to notify the transaction processing server 110 of whether the transaction requires enhanced servicing by assigning payment protections to a sender device (e.g., the communication device 150) as a remedy for any possible fraudulent activity with respect to the transaction based on the transaction type categorization. The subject technology includes the transaction application 151 running on the communication device 150 that can generate a transaction request to process a transaction to a recipient device (not shown) with a first service, in which the transaction request indicates a plurality of parameters associated with the transaction. The transaction application 151 can communicate, with the transaction processing server 110 through the network interface component 145, at least a portion of the transaction request including the plurality of parameters associated with the transaction.

The transaction application 151 can receive, from the transaction processing server 110 through the network interface component 145, an indication of one or more transaction type categorization options to assign to the transaction based on at least a portion of the plurality of parameters associated with the transaction. The transaction application 151 can provide, for display on a display device of the communication device 150, a prompt indicating the one or more transaction type categorization options for completing the transaction request. The transaction application 151 can receive, through the prompt, input indicating selection of a second transaction type categorization associated with a second service different from the first service from the one or more transaction type categorization options. In some aspects, the first service corresponds to a payment processing service for processing the transaction request as a peer-to-peer transaction to transfer monetary funds to a recipient device from a funding source associated with the transaction processing application, and the second service corresponds to a payment protection service for the sender device of the monetary funds by assigning the transaction type categorization to the transaction.

The transaction application 151 can communicate, with the transaction processing server 110 through the network interface component 145, the transaction request indicating the selection of the second transaction type categorization for processing the transaction with the first service and the second service. In this respect, the transaction processing server 110 can process the transaction request with payment protections assigned to the communication device 150 as the sender device, of which the user 105 associated with the communication device 150 can interact with the transaction processing server 110 through the transaction application 151 with peace of mind knowing the transaction has the payment protection service attached.

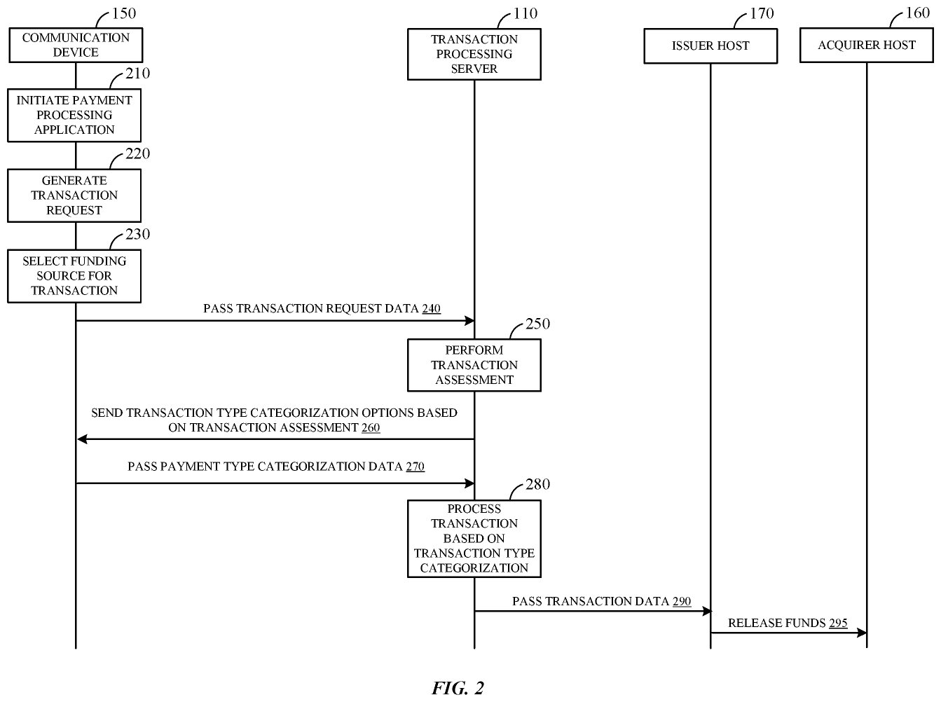

FIG. 2 illustrates a simplified message exchange in a networked system, according to an implementation of the present disclosure. The networked system includes the communication device 150 in a message exchange with the transaction processing server 110 for processing a transaction request with enhanced servicing by an electronic payment provider based on transaction type categorization, and the transaction processing server 110 in a message exchange with the issuer host 170.

Action 210, the communication device 150 initiates the transaction application 151, such as a payment processing application that facilitates transfer of monetary funds between a sender device, such as the communication device 150, and a recipient device. In some aspects, the transaction application 151 is a native application installed on the communication device 150. In other aspects, the transaction application 151 may be a web application that interfaces to a web server (not shown) that invokes the payment processing application.

At action 220, the communication device 150 generates a transaction request. For example, the transaction application 151 may provide for display a user interface that populates a prompt with editable sections for populating the transaction request with information needed to have the transaction fulfilled by the transaction processing server 110. As such, the transaction request may indicate a user account associated with the electronic payment provider as an intended recipient of the transaction and a transaction amount. The transaction application 151 may receive user input via the prompt on the user interface indicating the intended recipient. The user account may be identified with an alias that corresponds to an identifier of a user associated with the user account. In some aspects, the user interface may auto-populate the user account based on a partial entry of the intended recipient, of which the user account may be accessed from a user account repository (e.g., the user accounts database 123). In some aspects, the transaction request may indicate multiple user accounts as the intended recipients.

The transaction amount may correspond to a currency amount in terms of a specified currency dominion (e.g., USD). In some implementations, the transaction request includes a textual narrative generated at the communication device 150 with user-generated content identifying one or more aspects about the transaction, such as the purpose of the transaction, a message to the recipient, or any other narrative that helps identify the transaction to the recipient.

In some aspects, the transaction request may serve as a request to the transaction application 151 to send a payment to the intended recipient by accessing funds from the issuer host 170 and transfer the funds to the acquirer host 160 associated with the intended recipient when the transaction request is fulfilled by the transaction processing server 110 with acknowledgment from the issuer host 170. In other aspects, the transaction request may serve as a request (or demand) for payment from the recipient device to transfer funds to an acquiring bank associated with the communication device 150 as the requesting device.

Action 230, the communication device 150 selects a funding source for the transaction. In this regard, the transaction application 151 may receive user input indicating an issuing bank (e.g., the issuer host 170) that maintains the funds on behalf of the user 105 initiating the transaction.

At action 240, the communication device 150 passes transaction request data. In some aspects, the communication device 150 may transmit at least in part the transaction request data that includes user account identification for both the sender (e.g., the user 105) and recipient (e.g., merchant associated with the merchant server 140), the transaction amount and/or the selected funding source.

At action 250, the transaction processing server 110 receives the transaction request data and performs an assessment of the transaction request and/or the transaction. For example, the transaction processing server 110 may assess whether parameters included in the transaction request data satisfy one or more rules of a set of rules to determine whether the transaction is eligible to receive the payment protection service assigned by the electronic payment provider. A first rule of the set of rules, among others, may include whether the selected funding source corresponds to an expected funding source (e.g., sufficient balance in the specified bank account, non-expired debit card associated with the specified bank account, exclusion of any credit card account or margin account). A second rule of the set of rules may include determining whether a type of relationship between the sender and the recipient is a non-commercial relationship (e.g., direct friends) and/or determining whether a transactional history between the sender and recipient satisfies an expected transactional pattern and/or behavior. A third rule of the set of rules may include determining whether either of the sender user account and/or the recipient user account include any indication (or flag) identifying a potential risk or non-compliance with respect to the transaction. A fourth rule of the set of rules may include determining whether the transaction includes one or more features indicating the transaction is commercial with a level of confidence that exceeds a confidence threshold. A fifth rule of the set of rules may include determining whether a transactional history of payments to the recipient user account satisfies an expected transactional pattern and/or behavior. A sixth rule of the set of rules may include determining whether characteristics of the sender user account and/or the recipient user account satisfy an expected characteristic pattern and/or behavior. Another rule of the set of rules, among others, may include determining whether an estimated risk level of the transaction satisfies a risk threshold to obtain approval of the risk level.

At action 260, the transaction processing server 110 sends transaction type categorization options based on the transaction assessment. In this regard, when the transaction processing server 110 has determined that the transaction request has satisfied each rule of the set of rules, the transaction qualifies to receive processing with the first service (e.g., payment processing service) and the second service (e.g., payment protection against fraudulent activity). As such, the transaction processing server 110 provides, through the transaction processing application 121, a first transaction type categorization (e.g., non-commercial type transaction for processing with the first service) and a second transaction type categorization (e.g., a commercial type transaction for processing with the first service and (or without) the second service) to render as options on the user interface of the transaction application 151 at the communication device. In the event that the transaction request did not satisfy all of the rules, the transaction processing server 110 may provide the first transaction type categorization as the only option available for the transaction.

At action 270, the communication device 150 passes the payment type categorization data to the transaction processing server 110. The user interface of the transaction application 151 may receive user input indicating a selection of one of the transaction type categorizations for the transaction. In some aspects, the sender may opt to select the second transaction type categorization to have the transaction processed with the first service and the second service, and thereby receive the payment protection service for the transaction in the event a remedial action (e.g., a refund of funds issued to the sender) is needed in response to fraudulent activity associated with a commercial activity (e.g., sale of good or service) tied to the transaction (e.g., payment for the sale). In other aspects, the sender may opt to select the first transaction type categorization to have the transaction processed with the first service.

At action 280, the transaction processing server 110 processes the transaction based on the transaction type categorization. At action 290, the service provider server 110 passes the transaction data to the issuer host 170 for authenticating the transaction and fulfilling the transaction request. At action 295, the issuer host 170 may release the funds to be transferred to the acquirer host 160 to complete the payment to the recipient (e.g., merchant associated with the merchant server 140 if a commercial transaction).

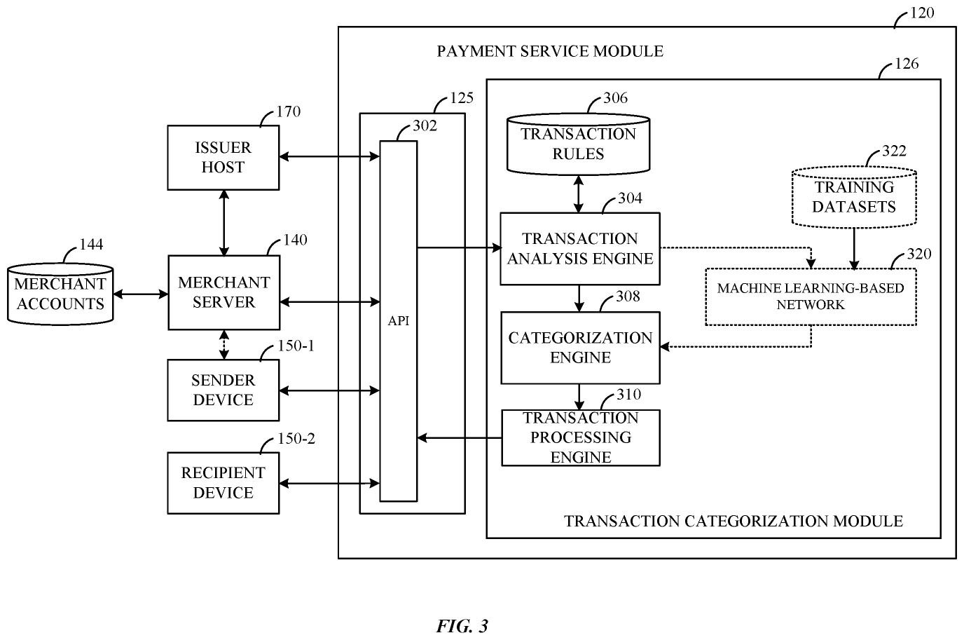

FIG. 3 illustrates a block diagram of the payment service module 120, according to an implementation of the present disclosure. The payment service module 120 includes the transaction categorization module 126 communicably coupled to the network interface component 125. The transaction categorization module 126 can interact with one or more communication devices 150 (depicted as “sender device 150-1” and “recipient device 150-2”), the merchant server 140 and/or the issuer host 170 via the network interface component 125.

The transaction categorization module 126 includes a transaction analysis engine 304, a transaction rules database 306, a categorization engine 308, and a transaction processing engine 310. In this regard, the network interface component 125 feeds input signaling to the transaction analysis engine 304, which is then fed to the categorization engine 308. The categorization engine 308 feeds its transaction type categorization selection to the transaction processing engine 310, which then feeds transaction data to the issuer host 170 via the network interface component 125.

In some implementations, the transaction categorization module 126 includes a machine learning-based network 320 and a training datasets database 322 for training the machine learning-based network 320. In some aspects, the transaction analysis engine 304 is coupled to an input to the machine learning-based network 320 and the categorization engine 308 is coupled to an output of the machine learning-based network 320.

In some aspects, the network interface component 125 includes API 302. In various aspect, the API 302 may correspond to a payment assessment API that is adapted to provide intelligence for digital payment transactions. A payment assessment API may be utilized by merchants that can leverage the power of a service provider network to authenticate and process their online transactions.

The transaction categorization module 126 may correspond to one or more processes to execute software modules and associated specialized hardware of transaction processing server 110 to analyze a transaction request containing transaction request data. Such transaction request data may include a network address of entities involved in a transaction. The entities, such as the sender device 150-1, may establish a connection to the merchant server 140 using the network address, by which the merchant server 140 acquires the network address as part of a process in registering and/or logging entities utilizing its service (e.g., uploading listings of items for sale through the online marketplace). The transaction request data may include other features and/or device attributes of the entity, such as the type of device of the entity, the screen display attributes, the user credentials stored on the entity, the type of web browser installed on the entity, or the like. The transaction request data may include information about the web browser application utilized to initiate the transaction. In some aspects, the transaction request data also may include the network address of the entity, the duration (e.g., amount of time elapsed) of the session (e.g., the connection between the sender device 150-1 and the merchant server 140), the login credentials utilized the entity to establish the session, cookie information indicating one or more web domains accessed by the entity during a time range, and the like. The transaction request data also may include transaction and merchant account information for a transaction and entities involved in the transaction to determine whether the transaction is eligible for a payment protection service. In this regard, the transaction categorization module 126 may correspond to specialized hardware and/or software to receive transaction information and/or access account information for assessing whether parameters included in the transaction request data satisfy one or more rules of a set of rules to determine whether the transaction is eligible to receive the payment protection service assigned by the electronic payment provider, thus increasing the user experience with the electronic payment provider platform. In some examples, the transaction information for a transaction may correspond to the name or other identifier for entities in the transaction, items involved in the transaction (e.g., sold to one or more entities), a cost of the transaction, additional costs (e.g., tax, tip, etc.), a message for the transaction (e.g., a shipping address, note to customer, item information, etc.), shipping information, and/or other information for the transaction.

The transaction categorization module 126 receives, from the transaction application 151 associated with the communication device 150 through the API 302, at least a portion of a transaction request including a plurality of parameters associated with a transaction for processing the transaction to the merchant server 140 (or the recipient device 150-2) with a first service.

The transaction categorization module 126, using the transaction analysis engine 304, determines whether at least a portion of the plurality of parameters associated with the transaction satisfy a set of rules for invoking a second service different from the first service.

The transaction rules database 306 may store, or record thereon, the set of rules utilized by the transaction analysis engine 304. A first rule of the set of rules, among others, may include whether the selected funding source corresponds to an expected funding source (e.g., sufficient balance in the specified bank account, non-expired debit card associated with the specified bank account, exclusion of any credit card account or margin account). A second rule of the set of rules may include determining whether a type of relationship between the sender and the recipient is a non-commercial relationship (e.g., direct friends) and/or determining whether a transactional history between the sender and recipient satisfies an expected transactional pattern and/or behavior. A third rule of the set of rules may include determining whether either of the sender user account and/or the recipient user account include any indication (or flag) identifying a potential risk or non-compliance with respect to the transaction. A fourth rule of the set of rules may include determining whether the transaction includes one or more features indicating the transaction is commercial with a level of confidence that exceeds a confidence threshold. A fifth rule of the set of rules may include determining whether a transactional history of payments to the recipient user account satisfies an expected transactional pattern and/or behavior. A sixth rule of the set of rules may include determining whether characteristics of the sender user account and/or the recipient user account satisfy an expected characteristic pattern and/or behavior. Another rule of the set of rules, among others, may include determining whether an estimated risk level of the transaction satisfies a risk threshold to obtain approval of the risk level.

The transaction categorization module 126, using the categorization engine 308, determines a plurality of transaction type categorization options respectively associated with the first service and the second service when the at least the portion of the plurality of parameters associated with the transaction is determined to satisfy the set of rules. The transaction categorization module 126 communicates, with the transaction application 151 through the API 302, an indication of the plurality of transaction type categorization options. In some aspects, the indication includes a request to the transaction processing application to assign one of the plurality of transaction type categorization options to the transaction.

The transaction categorization module 126 receives, from the transaction application 151 associated with the communication device 150 through the API 302, the transaction request indicating selection of a first transaction type categorization from the plurality of transaction type categorization options for processing the transaction with the first service and the second service. As such, the transaction categorization module 126, using the transaction processing engine 310, processes the transaction in response to the transaction request using the first service and the second service, and transmits transaction data to the issuer host 170, through the API 302, to process the transaction data and release the funds to the merchant server 140 via the acquirer host 160. In the event there is fraudulent activity associated with commercial activity (e.g., sale of good or service) tied to the transaction (e.g., payment for the sale) through the merchant server 140, the payment protection service can provide a remedy (e.g., issue a monetary refund) to the user account associated with the sender device 150-1 so that the user associated with the user account can interact with the electronic payment provider with peace of mind.

In other aspects of the subject technology, the transaction categorization module 126 communicates, with the transaction application 151 through the API 302, an indication of a transaction type categorization option when the at least the portion of the plurality of parameters associated with the transaction is determined not to satisfy the set of rules. In this regard, the transaction categorization module 126 receives, from the transaction application 151 associated with the communication device 150 through the API 302, the transaction request indicating selection of the transaction type categorization option for processing the transaction with the first service with exclusion from the second service.

Merchant account information from the merchant accounts database 144 may also be utilized by transaction categorization module 126 to determine whether a transactional history of payments to a recipient user account (e.g., a merchant account) satisfies an expected transactional pattern and/or behavior. The merchant account information may include entity information in the merchant account, financial information, past transactions using the merchant account, account purpose and use, and other accounts interacting with the merchant account. In this regard, a merchant account for a named merchant may be utilized to determine that the transaction type is commercial instead of personal for a transaction with a previously unknown user. Similarly, past transactions between the same merchant account and different entities and/or between the same entity and different merchant accounts maintained by the merchant server 140 may be analyzed by the transaction categorization module 126, such as prior instances where a merchant account was identified by the merchant server 140 as an account that was accessed by unauthorized entities performing a one-time transaction that resulted in a monetary loss to the legitimate merchant. Additionally, it may be detected whether different merchant accounts are linked or share an entity identifier, such as the same name, address, financial information, or other information, in order to determine a pattern in the types of transactions that result in a loss exposure to the merchant server 140.

The machine learning-based network 320, in one implementation, may be adapted to analyze one or more device features of the communication device 150 and generate a prediction result that indicates a likelihood that the transaction corresponds to a particular transaction type categorization. In this regard, the categorization engine 308 may mark the transaction with the predicted transaction type categorization by the machine learning-based network 320.

The structure of the machine learning-based network 320 may include a neural network with a particular pattern of layers or number of neurons per layer that are used to provide scoring information, such as a transaction type categorization prediction. The neural network structure can be based on input components. The input components can be based on transaction data. In some aspects, the input components represent the extracted features from the transaction data. In some examples, the extracted features may include a first feature indicating a type of transaction, a second feature indicating the monetary amount involved in the transaction, a third feature indicating the recipient (or user account) and an additional feature a time-of-day that the transaction occurred. Other features may include one or more sub-features of a user-generated narrative that accompanies the transaction request. In some implementations, the structure of the machine learning-based network 320 includes multiple neural networks, such that one of the neural networks is selected to perform a payment type categorization operation. In some aspects, the transaction categorization module 126 can select a prediction engine that includes a neural network among multiple prediction engines that include respective neural networks. Each of the different neural networks may correspond to a respective type of transaction categorization.

The machine learning-based network 320 may implement specific algorithms to process the transaction data to determine the transaction type categorization prediction. For example, the machine learning-based network 320 may be implemented by a log regression algorithm to perform either a binary classification or multi-class classification.

In some aspects, the input data to the machine learning-based network 320 can be normalized, transformed, have outliers removed, or otherwise processed so that its characteristics can help the machine learning-based network 320 produce quality results. The input data may be further transformed into several components to be used in the machine learning-based network 320.

The machine learning-based network 320 or other front-end parsing module (not shown) may generate the input components using multiple variables for a particular device. For example, the input components may be created based on an inference-based data set and predictive methodology to determine the value based on the history of similar variable combinations.

The machine learning-based network 320 may be trained using the training datasets 322. The machine learning-based network 320 can be trained with the transaction data already stored in the service provider server. In some implementations, aspects of the machine learning-based network 320 can trained with specific subsets of the training data. The machine learning-based network 320 can be trained with historical transaction data that covers a specified range of time (e.g., the last 18 months of transactions). The machine learning-based network 320 can be updated with further training on later phases and through a process for periodic review. In some aspects, the training of the machine learning-based network 320 may employ a form of parallel processing in order to reduce training time. For example, the training may be performed in a closed offline environment with map reduce technology.

The transaction categorization module 126 may perform post-processing and interpretation of the output data from the machine learning-based network. For example, the output of the machine learning-based network 320 may be transformed, normalized or run through another algorithm to provide useful output data.

Training datasets 322 may store data necessary for training and utilizing the machine learning-based network 320, such as training data that may include transactions used to train the machine learning-based network 320 or artificial intelligence (AI) model and any feedback from the merchant server 140 regarding a transactional history between the merchant server 140 and the sender device 150-1. In some aspects, training datasets 322 includes training data for transactions reviewed for satisfying any of the set of rules is accessed. The training data may correspond to data sets having different data points (e.g., transactions) that may be processed or accessible to an entity, such as those processed by an online transaction processor, financial entity, or other payment processor. In this regard, the training data may include different features and/or attributes, where these describe the transactions interacted with the sender device 150-1 and allow for decision-making based on the interactions with the sender device 150-1. Further training datasets 322 may include merchant device behavior data used for training the machine learning-based network 320 for identifying any transactional patterns between the merchant server 140 and the sender device 150-1, identifying any potential risk or non-compliance with respect to the subject transaction, and/or processing future transactions by the payment service module 120 or another transaction processing entity, where transactions may be processed by the machine learning-based network 320 to identify different transaction types (e.g., commercial or non-commercial) based on transaction patterns involving the sender device 150-1, the recipient device 150-2, and/or the merchant server 140 and predict a transaction type categorization that indicates the type of transaction being transacted between the sender device 150-1 and the merchant server 140 (e.g., commercial transaction) or the recipient device 150-2 (e.g., non-commercial transaction).

Training datasets 322 may further include labels for the training data and/or transactions processed by the payment service module 120. In some aspects, the training data labels include a description of why the machine learning-based network 320 flagged particular transactions as a certain transaction type categorization. In some implementations, classifiers for the data may be designated (e.g., “commercial transaction”) and/or the data sets may be annotated or labeled with particular transactions flagged as commercial. The training data may therefore include data that may be processed by agents (not shown) of the transaction processing server 110 or other entity to determine whether any of the transactions indicate commercial activity or other commercial transaction behavior. Moreover, the training data may also include transaction data processed by a regulatory agency of those transactions that are actually commercial (e.g., a sale or purchases of a good or service through commerce) and those that are non-commercial or do not rise to the degree of commercial behavior to cause an action. Thus, such data may be labeled.

The training datasets 322 may include different features, such as a platform for the transaction (e.g., mobile, web, etc.), an account number, a transaction identifier (ID), a transaction type (e.g., payment, gambling, etc.), an encrypted transaction ID, a parent transaction ID, a created and/or update date, a US dollar equivalent amount (e.g., where credits and sent payments may be in a negative format), a local currency amount and/or code, a billing and/or shipping address, a funding source and/or backup funding source, a bank account number, a bank hash-based message authentication code (HMAC), a card number and/or hash, a card bun HMAC, a card issuer, a balance and/or impact on a balance due to the transaction, a transaction status and/or items within the transaction, notes and/or subject lines within messages for the transaction, an automated clearinghouse return codes, an ID on another marketplace or platform, a counterparty name, a counterparty account number, a counterparty account type, a counterparty country code, a counterparty email, a counterparty transaction ID, a counterparty ID on a marketplace or platform, a counterparty account status, a referring URL, an IP address, whether the transaction was successful, and a date (e.g., month/year) of transaction.

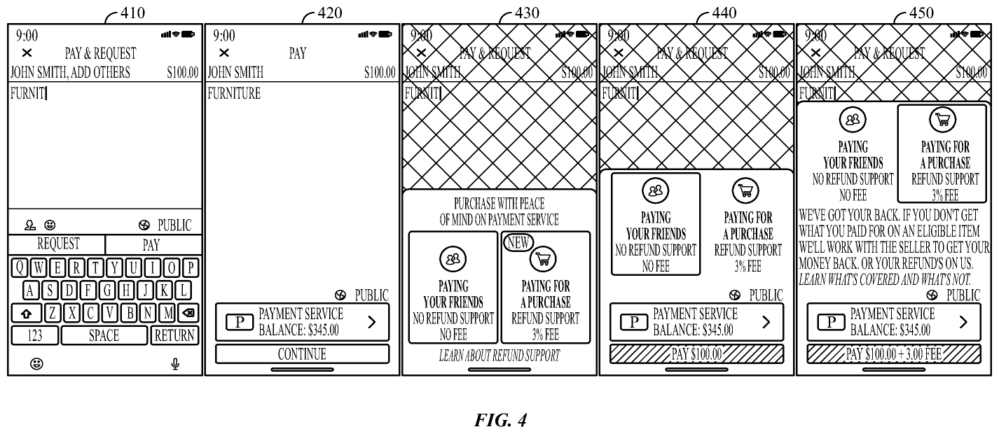

FIG. 4 conceptually illustrates an exemplary workflow of transaction type categorization through a user interface, according to an implementation of the present disclosure. At interface 410, the transaction processing application can generate a transaction request to process a transaction to a recipient device with a first service, the transaction request indicating a plurality of parameters associated with the transaction. For example, the interface 410 can provide, for display, a prompt indicating one or more recipient device options for completing the transaction request. In some aspects, the plurality of parameters includes a selection of the one or more recipient device options (or user accounts associated with the electronic payment provider). In some examples, the interface 410 can receive, through the prompt, a textual narrative comprising user-generated content indicating at least in part a type of the transaction.

At interface 420, the transaction processing application can provide, for display, a second prompt indicating one or more funding source options for completing the transaction request. In some aspects, the plurality of parameters includes a selection of the one or more funding source options. In some implementations, the plurality of parameters comprises a currency amount of the transaction, a funding source for the transaction, a type of relationship between a sender device initiating the transaction request and the recipient device, a transactional history associated with the recipient device, or account characteristics associated with the sender device and the recipient device. In some aspects, the transaction processing application can communicate, with a transaction processing server through an API, at least a portion of the transaction request including the plurality of parameters associated with the transaction.

At interface 430, the transaction processing application can provide, for display, a prompt indicating the one or more transaction type categorization options for completing the transaction request. In some aspects, the transaction processing application can receive, from the transaction processing server through the API, an indication of one or more transaction type categorization options to assign to the transaction based on at least a portion of the plurality of parameters associated with the transaction.

At interface 440, the transaction processing application can provide, for display, the prompt indicating a first transaction type categorization associated with the first service and the second transaction type categorization associated with a second service. The transaction processing application can receive, through the prompt, input indicating selection of the first transaction type categorization associated with the first service. In some implementations, the interface 440 can provide, for display, a prompt requesting confirmation of the selection of the second transaction type categorization associated with the second service and a selection of a funding source associated with the transaction request. In some aspects, the transaction processing application can communicate, with the transaction processing server through the API, the transaction request indicating the selection of the first transaction type categorization for processing the transaction with the first service with exclusion of the second service

At interface 450, the transaction processing application can receive, through the prompt, input indicating selection of a second transaction type categorization associated with a second service different from the first service from the one or more transaction type categorization options. In some aspects, the transaction processing application can communicate, with the transaction processing server through the API, the transaction request indicating the selection of the second transaction type categorization for processing the transaction with the first service and the second service.

In some aspects, the first service corresponds to a payment processing service for processing the transaction request as a peer-to-peer transaction to transfer monetary funds to the recipient device from a funding source associated with the transaction processing application. In other aspects, the second service corresponds to a payment protection service for a sender device of the monetary funds by assigning the one or more transaction type categorization options to the transaction.

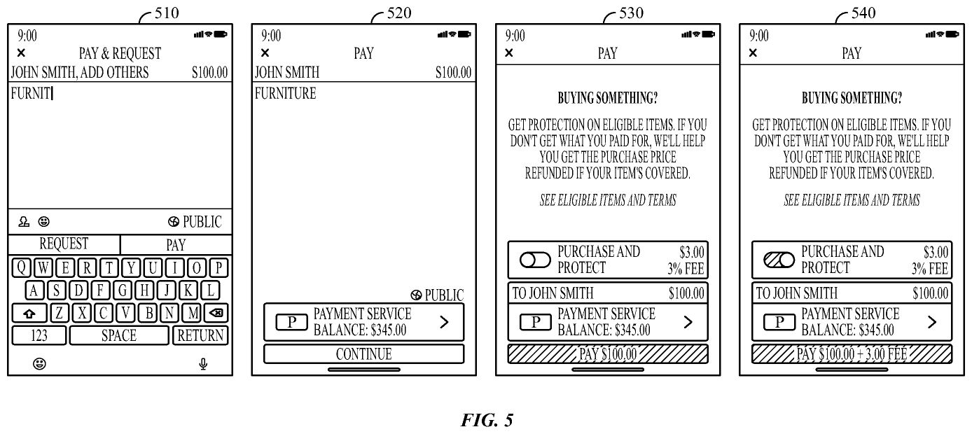

FIG. 5 conceptually illustrates another exemplary workflow of transaction type categorization through a user interface, according to an implementation of the present disclosure. At interface 510, the transaction processing application can generate a transaction request to process a transaction to a recipient device with a first service, the transaction request indicating a plurality of parameters associated with the transaction. At interface 520, the transaction processing application can provide, for display, a second prompt indicating one or more funding source options for completing the transaction request. At interface 530, the transaction processing application can provide, for display, a prompt indicating whether the transaction pertains to a commercial transaction for completing the transaction request. At interface 540, the transaction processing application can receive, through the prompt, input indicating selection of an option identifying the transaction as a commercial transaction. In some aspects, the transaction processing application can communicate, with the transaction processing server through the API, the transaction request indicating the transaction as a commercial transaction for processing the transaction with the first service and the second service.

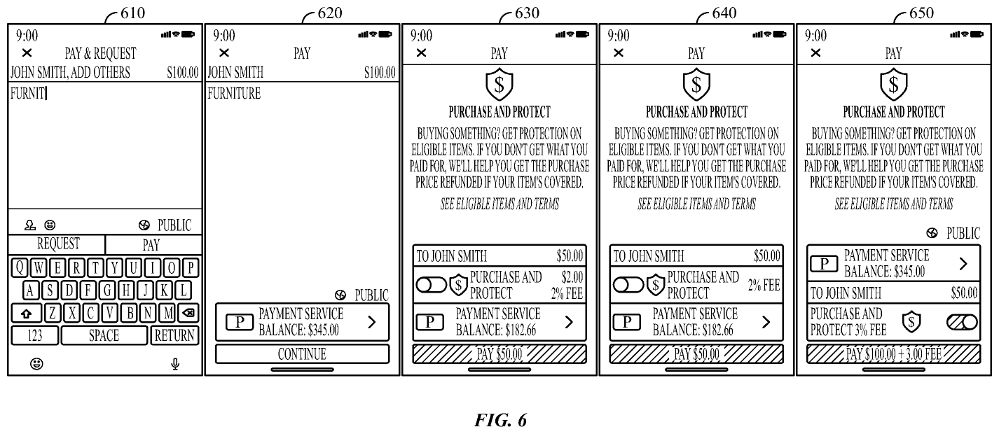

FIG. 6 conceptually illustrates yet another exemplary workflow of transaction type categorization through a user interface, according to an implementation of the present disclosure. At interface 610, the transaction processing application can generate a transaction request to process a transaction to a recipient device with a first service, the transaction request indicating a plurality of parameters associated with the transaction. At interface 620, the transaction processing application can provide, for display, a second prompt indicating one or more funding source options for completing the transaction request. At interface 630, the transaction processing application can provide, for display, a prompt indicating whether the transaction pertains to a commercial transaction for completing the transaction request along with a cost associated with the second service in terms of a percentage and a currency value. Alternatively, at interface 640, the transaction processing application can provide, for display, the prompt indicating whether the transaction pertains to a commercial transaction for completing the transaction request along with a cost associated with the second service in terms of a percentage only. At interface 650, the transaction processing application can receive, through the prompt, input indicating selection of an option identifying the transaction as a commercial transaction. In some aspects, the transaction processing application can communicate, with the transaction processing server through the API, the transaction request indicating the transaction as a commercial transaction for processing the transaction with the first service and the second service.

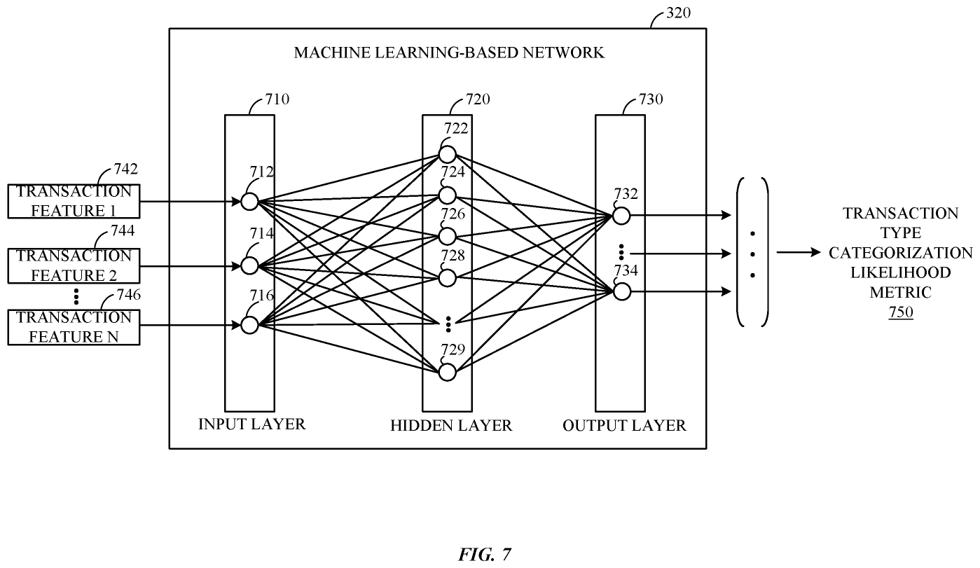

FIG. 7 is an exemplary system environment of an artificial neural network implementing a machine learning model trained for classifications based on training data, according to an implementation of the present disclosure. In this regard, neural network 700 shows an input layer 710, a hidden layer 720, and an output layer 730 of the artificial neural network implementing a machine learning model trained as discussed herein, where the nodes and weights for the hidden layer may be trained using one or more training data sets of transactions for identification of patterns of prohibited conduct or behavior in transaction performance (e.g., transaction processing between users or other entities).

For example, when training machine learning-based network 320, one or more training data sets of training datasets 322 for transactions having different features and feature values may be processed using a supervised machine learning algorithm or technique, such as gradient boosting or random forest algorithms. In some implementations, other types of AI learning may be used, such as deep learning for neural networks. The features within training datasets 322 may include different types of variables, parameters, or characteristics of the underlying transactions, which may have separate values to the variables. This allows for different classifiers of the transactions and variables to be built into known or desired classifications (e.g., certain transaction type categorization). These classifiers are trained to detect the transactions of training datasets 322 falling into the classifier using the machine learning technique, which allows identification of similar transactions meeting a specific classification. The classifiers may be generated by the machine learning technique when identifying and grouping transactions and/or designated by a user or agent of the training data set. Thus, training datasets 322 may include transactions falling into specific classifications, such as non-commercial type transaction categorization or commercial type transaction categorization. The process may be supervised where the output and classifications are known for the transactions. In some implementations, the training data set may include annotated or labeled data of particular flagged transactions and/or may be reviewed after processed and classified by the machine learning technique for false positives and/or correctly identified and flagged as a certain transaction type categorization.

Neural network 700 may implement machine learning-based network 320 (e.g., a model trained using training datasets 322 of transactions having a distribution of transactions with different risk levels). Neural network 700 includes different layers and nodes to perform decision-making using the machine learning-based network 320. Each of layers 710, 720, and 730 may include one or more nodes. For example, input layer 710 includes nodes 712-716, hidden layer 720 includes nodes 722-729, and output layer 730 includes nodes 732-734. In this example, each node in a layer is connected to every node in an adjacent layer. For example, node 712 in input layer 710 is connected to all of nodes 722-729 in hidden layer 720. Similarly, node 722 in the hidden layer is connected to all of nodes 712-716 in input layer 710 and nodes 732-734 in output layer 730. Although only one hidden layer is shown for neural network 700, it has been contemplated that neural network 700 used to implement the machine learning-based network 320 for device risk assessment may include as many hidden layers as desired.

In this example, neural network 700 receives a set of input values (e.g., transaction features 742-746) and produces an output vector (or singular value). Each node in input layer 710 may correspond to a distinct input value. For example, when neural network 700 is used to implement the machine learning-based network 320 for payment type categorization, each node in the input layer 710 may correspond to a distinct attribute derived from the information associated with a user device (e.g., communication device 150) or a user account. In some aspects, the information pertains to a transaction (e.g., a transaction time, currency amount, recipient, USD equivalent amount, balance affect or account balance, local or general time/date, etc.). In a non-limiting example, node 712 receives transaction feature 742 (depicted as “transaction feature 1”) that may correspond to an account identifier or name, node 714 receives transaction feature 744 (depicted as “transaction feature 2”) that may correspond to a network address used by a sending or receiving merchant account, and node 716 receives transaction feature 746 (depicted as “transaction feature N”) that may correspond to an amount for the transaction. In some aspects, the nodes 712-716 may correspond to an encoded value representing a set of additional values derived from training datasets 322.

In some implementations, each of nodes 722-729 in hidden layer 720 generates a representation, which may include a mathematical computation (or algorithm) that produces a value based on the input values received from nodes 712-716. The mathematical computation may include assigning different weights to each of the data values received from nodes 712-716. In some instances, the weights can be identified based on the relevance to a particular transaction type categorization. For example, nodes 722-729 may include different algorithms and/or different weights assigned to the data variables from nodes 712-716 such that each of nodes 722-729 may produce a different value based on the same input values received from nodes 712-716. In some implementations, the weights that are initially assigned to the features (or input values) for each of nodes 722-729 may be randomly generated (e.g., using a computer randomizer). The values generated by nodes 722-729 may be used by each of nodes 732-734 in output layer 730 to produce an output value for neural network 700. When neural network 700 is used to implement the machine learning-based network 320 for device risk assessment, the output value produced by neural network 700 may indicate a likelihood that a transaction has a particular transaction type categorization. In some aspects, the neural network 700 may output a vector of likelihood values, where each likelihood value pertains to a different transaction type categorization.

The artificial neural network 700 may be trained by using historical electronic transaction data (training data). The historical electronic transaction data may include transaction records for different time periods in the past (e.g., July 2019 through March 2020, July 2018 through March 2019, July 2017 through March 2020, etc.). By providing the training data to the artificial neural network 700, the nodes 722-729 in the hidden layer 720 may be trained (adjusted) such that an optimal output (e.g., a likelihood of a transaction having a particular transaction type categorization at a particular time with respect to a recipient merchant account or a recipient non-commercial account) is produced in the output layer 730 based on the training data. For example, the output layer 730 can produce a transaction type categorization likelihood metric 750 that includes the optimal output of the artificial neural network 700. In some aspects, the transaction type categorization likelihood metric 750 is a vector of likelihood values. In other aspects, the transaction type categorization likelihood metric 750 is a singular value. By continuously providing different sets of training data and penalizing the artificial neural network 700 when the output is incorrect, the artificial neural network 700 (and specifically, the representations of the nodes in the hidden layer 720) may be trained (adjusted) to improve its performance in transaction type categorizations for different transactions over time. Adjusting the artificial neural network 700 may include adjusting the weights associated with each node in the hidden layer 720.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

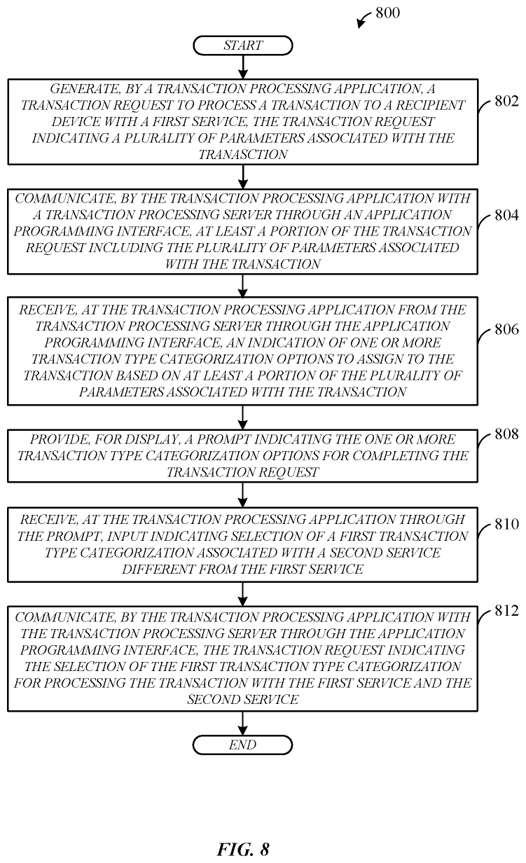

FIG. 8 is a flowchart of an example process of transaction type categorization by a transaction processing application at a user device, according to an implementation of the present disclosure. One or more of the steps 802-808 of process 800 may be implemented, at least in part, in the form of executable code stored on non-transitory, tangible, machine-readable media that when run by one or more processors may cause the one or more processors to perform one or more of the steps 802-808. Some examples of computing devices, such as computing system 1000 may include non-transitory, tangible, machine readable media that include executable code that when run by one or more processors (e.g., processor 1012) may cause the one or more processors to perform the steps of process 800. As illustrated, the process 800 includes a number of enumerated steps, but aspects of the process 800 may include additional steps before, after, and in between the enumerated steps. In some aspects, one or more of the enumerated steps may be omitted or performed in a different order.

The process 800 starts at step 802, where the transaction processing application 121 generates a transaction request to process a transaction to a recipient device with a first service, the transaction request indicating a plurality of parameters associated with the transaction. Next, at step 804, the transaction processing application 121 communicates, with a transaction processing server through an API, at least a portion of the transaction request including the plurality of parameters associated with the transaction. Subsequently, at step 806, the transaction processing application 121 receives, from the transaction processing server through the API, an indication of one or more transaction type categorization options to assign to the transaction based on at least a portion of the plurality of parameters associated with the transaction. Next, at step 808, the transaction processing application 121 provides, for display, a prompt indicating the one or more transaction type categorization options for completing the transaction request. Subsequently, at step 810, the transaction processing application 121 receives, through the prompt, input indicating selection of a second transaction type categorization associated with a second service different from the first service from the one or more transaction type categorization options. Next, at step 812, the transaction processing application 121 communicates, with the transaction processing server through the API, the transaction request indicating the selection of the second transaction type categorization for processing the transaction with the first service and the second service.

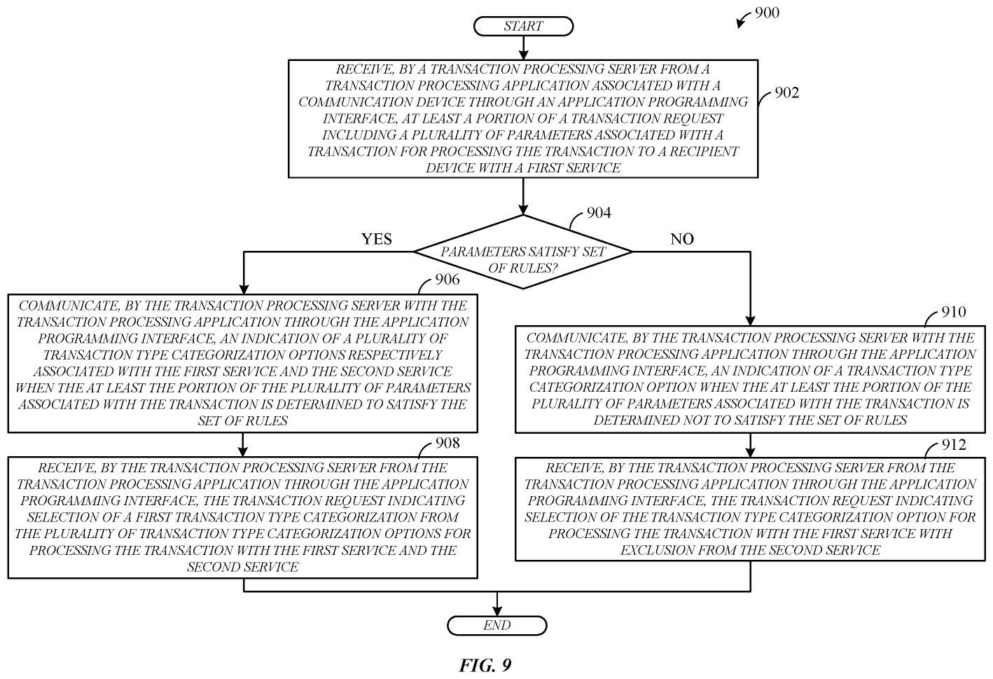

FIG. 9 is a flowchart of an example process of transaction type categorization by a service provider server, according to an implementation of the present disclosure. One or more of the steps 902-908 of process 900 may be implemented, at least in part, in the form of executable code stored on non-transitory, tangible, machine-readable media that when run by one or more processors may cause the one or more processors to perform one or more of the steps 902-908. Some examples of computing devices, such as computer system 1000 may include non-transitory, tangible, machine readable media that include executable code that when run by one or more processors (e.g., processor 1012) may cause the one or more processors to perform the steps of process 900. As illustrated, the process 900 includes a number of enumerated steps, but aspects of the process 900 may include additional steps before, after, and in between the enumerated steps. In some aspects, one or more of the enumerated steps may be omitted or performed in a different order.

The process 900 begins at step 902, where the transaction processing server 110 receives, from the transaction application 151 associated with the communication device 150 through the API 302, at least a portion of a transaction request including a plurality of parameters associated with a transaction for processing the transaction to a recipient device with a first service. Next, at step 904, the transaction processing server 110 determines whether at least a portion of the plurality of parameters associated with the transaction satisfy a set of rules for invoking a second service different from the first service. If the parameters satisfy the set of rules, then the process 900 proceeds to step 906. Otherwise, the process 900 proceeds to step 910. Subsequently, at step 906, the transaction processing server 110 communicates, with the transaction application 151 through the API 302, an indication of a plurality of transaction type categorization options respectively associated with the first service and the second service when the at least the portion of the plurality of parameters associated with the transaction is determined to satisfy the set of rules. In some aspects, the indication includes a request to the transaction processing application to assign one of the plurality of transaction type categorization options to the transaction. Next, at step 908, the transaction processing server 110 receives, from the transaction application 151 associated with the communication device 150 through the API 302, the transaction request indicating selection of a first transaction type categorization from the plurality of transaction type categorization options for processing the transaction with the first service and the second service.

At step 910, the transaction processing server 110 communicates, with the transaction application 151 through the API 302, an indication of a transaction type categorization option when the at least the portion of the plurality of parameters associated with the transaction is determined not to satisfy the set of rules. Next, at step 912, the transaction processing server 110 receives, from the transaction application 151 associated with the communication device 150 through the API 302, the transaction request indicating selection of the transaction type categorization option for processing the transaction with the first service with exclusion from the second service.

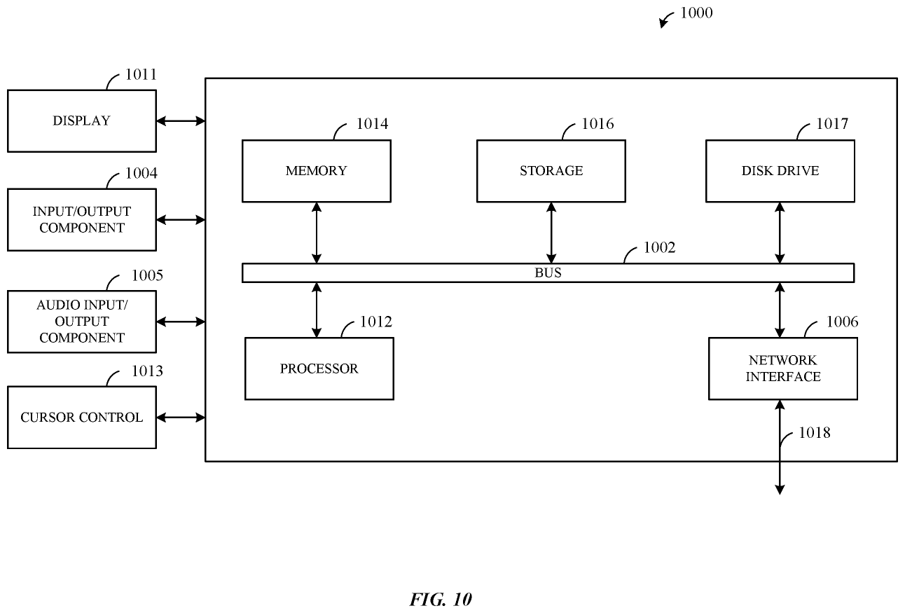

FIG. 10 is a block diagram of a computer system 1000 suitable for implementing one or more components in FIG. 1, according to an implementation. In various implementations, a computing device may include a personal computing device e.g., smart phone, a computing tablet, a personal computer, laptop, a wearable computing device such as glasses or a watch, Bluetooth device, key FOB, badge, etc.) capable of communicating with the network. The transaction processing server 110 may utilize a network computing device (e.g., a network server) capable of communicating with the network 180. It should be appreciated that each of the devices utilized by users and service providers may be implemented as computer system 1000 in a manner as follows.

Computer system 1000 includes a bus 1002 or other communication mechanism for communicating information data, signals, and information between various components of computer system 1000. Components include an input/output (I/O) component 1004 that processes a user action, such as selecting keys from a keypad/keyboard, selecting one or more buttons, image, or links, and/or moving one or more images, etc., and sends a corresponding signal to bus 1002. I/O component 1004 may also include an output component, such as a display 1011 and a cursor control 1013 (such as a keyboard, keypad, mouse, etc.). An optional audio input/output component 1005 may also be included to allow a user to use voice for inputting information by converting audio signals. Audio I/O component 1005 may allow the user to hear audio. A transceiver or network interface 1006 transmits and receives signals between computer system 1000 and other devices, such as another communication device, service device, or a service provider server via network 180. In one implementation, the transmission is wireless, although other transmission mediums and methods may also be suitable. One or more processors 1012, which can be a micro-controller, digital signal processor (DSP), or other processing component, processes these various signals, such as for display on computer system 1000 or transmission to other devices via a communication link 1018. Processor(s) 1012 may also control transmission of information, such as cookies or IP addresses, to other devices.

Components of computer system 1000 also include a system memory component 1014 (e.g., RAM), a static storage component 1016 (e.g., ROM), and/or a disk drive 1017. Computer system 1000 performs specific operations by processor(s) 1012 and other components by executing one or more sequences of instructions contained in system memory component 1014. Logic may be encoded in a computer readable medium, which may refer to any medium that participates in providing instructions to processor(s) 1012 for execution. Such a medium may take many forms, including but not limited to, non-volatile media, volatile media, and transmission media. In various implementations, non-volatile media includes optical or magnetic disks, volatile media includes dynamic memory, such as system memory component 1014, and transmission media includes coaxial cables, copper wire, and fiber optics, including wires that include bus 1002. In one implementation, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various implementations of the present disclosure, execution of instruction sequences to practice the present disclosure may be performed by computer system 1000. In various other implementations of the present disclosure, a plurality of computer systems 1000 coupled by communication link 1018 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various implementations provided by the present disclosure may be implemented using hardware, software, or combinations of hardware and software. Also, where applicable, the various hardware components and/or software components set forth herein may be combined into composite components that include software, hardware, and/or both without departing from the spirit of the present disclosure. Where applicable, the various hardware components and/or software components set forth herein may be separated into sub-components that include software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems that include one or more memories storing various information described herein and one or more processors coupled to the one or more memories and a network, wherein the one or more processors are operable to perform steps as described herein, as non-transitory machine-readable medium that includes a plurality of machine-readable instructions which, when executed by one or more processors, are adapted to cause the one or more processors to perform a method that includes steps described herein, and methods performed by one or more devices, such as a hardware processor, user device, server, and other devices described herein.

The foregoing disclosure is not intended to limit the present disclosure to the precise forms or particular fields of use disclosed. As such, it is contemplated that various alternate implementations and/or modifications to the present disclosure, whether explicitly described or implied herein, are possible in light of the disclosure. Having thus described implementations of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
generating, by a transaction processing application, a transaction request to process a transaction to a recipient device with a first service, the transaction request indicating a plurality of parameters associated with the transaction;
communicating, by the transaction processing application with a transaction processing server through an application programming interface, at least a portion of the transaction request including the plurality of parameters associated with the transaction;
receiving, at the transaction processing application from the transaction processing server through the application programming interface, an indication of one or more transaction type categorization options to assign to the transaction based on at least a portion of the plurality of parameters associated with the transaction;
providing, for display, a prompt indicating the one or more transaction type categorization options for completing the transaction request;
receiving, at the transaction processing application through the prompt, input indicating selection of a second transaction type categorization associated with a second service different from the first service from the one or more transaction type categorization options; and
communicating, by the transaction processing application with the transaction processing server through the application programming interface, the transaction request indicating the selection of the second transaction type categorization for processing the transaction with the first service and the second service.

2. The system of claim 1, wherein the plurality of parameters comprises a currency amount of the transaction, a funding source for the transaction, a type of relationship between a sender device initiating the transaction request and the recipient device, a transactional history associated with the recipient device, or account characteristics associated with the sender device and the recipient device.

3. The system of claim 1, wherein the operations further comprise:
providing, for display, a second prompt indicating one or more funding source options for completing the transaction request, wherein the plurality of parameters includes a selection of the one or more funding source options.

4. The system of claim 1, wherein the operations further comprise:
providing, for display, a third prompt indicating one or more recipient device options for completing the transaction request, wherein the plurality of parameters includes a selection of the one or more recipient device options.

5. The system of claim 4, wherein the operations further comprise:
receiving, through the third prompt, a textual narrative comprising user-generated content indicating at least in part a type of the transaction.

6. The system of claim 1, wherein the operations further comprise:
providing, for display, a fourth prompt requesting confirmation of the selection of the second transaction type categorization associated with the second service and a selection of a funding source associated with the transaction request.

7. The system of claim 1, wherein the providing the prompt indicating the one or more transaction type categorization options comprises providing, for display, the prompt indicating a first transaction type categorization associated with the first service and the second transaction type categorization associated with the second service,
wherein the operations further comprise:
receiving, at the transaction processing application through the prompt, input indicating selection of the first transaction type categorization associated with the first service; and
communicating, by the transaction processing application with the transaction processing server through the application programming interface, the transaction request indicating the selection of the first transaction type categorization for processing the transaction with the first service with exclusion of the second service.

8. The system of claim 1, wherein the first service corresponds to a payment processing service for processing the transaction request as a peer-to-peer transaction to transfer monetary funds to the recipient device from a funding source associated with the transaction processing application, and wherein the second service corresponds to a payment protection service for a sender device of the monetary funds by assigning the one or more transaction type categorization options to the transaction.

9. A method, comprising
receiving, by a transaction processing server from a transaction processing application associated with a communication device through an application programming interface, at least a portion of a transaction request including a plurality of parameters associated with a transaction for processing the transaction to a recipient device with a first service;
determining whether at least a portion of the plurality of parameters associated with the transaction satisfy a set of rules for invoking a second service different from the first service;
communicating, by the transaction processing server with the transaction processing application through the application programming interface, an indication of a plurality of transaction type categorization options respectively associated with the first service and the second service when the at least the portion of the plurality of parameters associated with the transaction is determined to satisfy the set of rules, the indication including a request to the transaction processing application to assign one of the plurality of transaction type categorization options to the transaction; and
receiving, by the transaction processing server from the transaction processing application associated with the communication device through the application programming interface, the transaction request indicating selection of a first transaction type categorization from the plurality of transaction type categorization options for processing the transaction with the first service and the second service.

10. The method of claim 9, further comprising:
communicating, by the transaction processing server with the transaction processing application through the application programming interface, an indication of a transaction type categorization option when the at least the portion of the plurality of parameters associated with the transaction is determined not to satisfy the set of rules, the indication including a request to the transaction processing application to assign the transaction type categorization option to the transaction.

11. The method of claim 10, further comprising:
receiving, by the transaction processing server from the transaction processing application associated with a communication device through an application programming interface, the transaction request indicating selection of the transaction type categorization option for processing the transaction with the first service with exclusion from the second service.

12. The method of claim 9, wherein the plurality of parameters comprises a currency amount of the transaction, a funding source for the transaction, a type of relationship between a sender device initiating the transaction request and the recipient device, a transactional history associated with the recipient device, or account characteristics associated with the sender device and the recipient device.

13. A non-transitory machine-readable medium having stored thereon machine-readable instructions executable to cause a machine to perform operations comprising:
generating, by a transaction processing application, a transaction request to process a transaction to a recipient device with a first service, the transaction request indicating a plurality of parameters associated with the transaction;
communicating, by the transaction processing application with a transaction processing server through an application programming interface, at least a portion of the transaction request including the plurality of parameters associated with the transaction;
receiving, at the transaction processing application from the transaction processing server through the application programming interface, an indication of one or more transaction type categorization options to assign to the transaction based on at least a portion of the plurality of parameters associated with the transaction;
providing, for display, a prompt indicating the one or more transaction type categorization options for completing the transaction request;
receiving, at the transaction processing application through the prompt, input indicating selection of a second transaction type categorization associated with a second service different from the first service from the one or more transaction type categorization options; and
communicating, by the transaction processing application with the transaction processing server through the application programming interface, the transaction request indicating the selection of the second transaction type categorization for processing the transaction with the first service and the second service.

14. The non-transitory machine-readable medium of claim 13, wherein the plurality of parameters comprises a currency amount of the transaction, a funding source for the transaction, a type of relationship between a sender device initiating the transaction request and the recipient device, a transactional history associated with the recipient device, or account characteristics associated with the sender device and the recipient device.

15. The non-transitory machine-readable medium of claim 13, wherein the operations further comprise:
providing, for display, a second prompt indicating one or more funding source options for completing the transaction request, wherein the plurality of parameters includes a selection of the one or more funding source options.

16. The non-transitory machine-readable medium of claim 13, wherein the operations further comprise:
providing, for display, a third prompt indicating one or more recipient device options for completing the transaction request, wherein the plurality of parameters includes a selection of the one or more recipient device options.

17. The non-transitory machine-readable medium of claim 16, wherein the operations further comprise:
receiving, through the third prompt, a textual narrative comprising user-generated content indicating at least in part a type of the transaction.

18. The non-transitory machine-readable medium of claim 13, wherein the operations further comprise:
providing, for display, a fourth prompt requesting confirmation of the selection of the second transaction type categorization associated with the second service and a selection of a funding source associated with the transaction request.

19. The non-transitory machine-readable medium of claim 13, wherein the providing the prompt indicating the one or more transaction type categorization options comprises providing, for display, the prompt indicating a first transaction type categorization associated with the first service and the second transaction type categorization associated with the second service,
wherein the operations further comprise:
receiving, at the transaction processing application through the prompt, input indicating selection of the first transaction type categorization associated with the first service; and
communicating, by the transaction processing application with the transaction processing server through the application programming interface, the transaction request indicating the selection of the first transaction type categorization for processing the transaction with the first service with exclusion of the second service.

20. The non-transitory machine-readable medium of claim 13, wherein the first service corresponds to a payment processing service for processing the transaction request as a peer-to-peer transaction to transfer monetary funds to the recipient device from a funding source associated with the transaction processing application, and wherein the second service corresponds to a payment protection service for a sender of the monetary funds by assigning the one or more transaction type categorization options to the transaction with the recipient device.
